(19) United States
(12) Patent Application Publication
(10) Pub. No.: US 2007/0161459 A1
(43) Pub. Date: Jul. 12, 2007

(54) Multi-functional USB exercise data storage device

(76) Inventor: Edward M. Watson, Madison, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/642,216

(22) Filed: Dec. 20, 2006

Related U.S. Application Data
(60) Provisional application No. 60/751,592, filed on Dec. 20, 2005.

(51) Int. Cl. G01V 7/00; A63B 71/00

(52) U.S. Cl. 482/8; 702/2

(57) ABSTRACT

A performance data storage device is provided that enables an individual performing an exercise session to record and transmit data concerning the exercise session in a real time manner using a mechanical interface or in a wireless manner. The device is capable of storing performance data for a number of exercise sessions and downloading the data to a separate computing device to analyze the data. Additionally, the device stores this data in conjunction with additional user information, such as a user identification code and exercise machine set-up parameters, in order to enable the device to set up an exercise machine for use by an individual prior to beginning any subsequent exercise session. The device can communicate with a computer using a USB standard protocol yet be able to communicate with a USB peripheral device, i.e., an exercise machine console, without the need for a USB host device.

### CROSS-REFERENCE TO RELATED APPLICATIONS

This application claims priority from U.S. Provisional Patent Application Ser. No. 60/751,592, filed on Dec. 20, 2005, the entirety of which is expressly incorporated by reference.

### BACKGROUND AND SUMMARY OF THE INVENTION

When an individual is performing an exercise on an exercise machine during an exercise session, the machine typically displays performance data to the individual on a console formed as part of the exercise machine. In order to review this data and provide an objective measure as to the change in performance level of an individual performing an exercise on a machine, it is desirable to be able to be able to record the performance data that is representative of various parameters of the individual's workout or workouts on the exercise machine.

A number of different systems have been developed which enable an individual to record performance data from an individual exercise session and compare the data with prior or subsequent sessions to analyze and measure the change in the performance data for the individual. Typically, such systems involve a number of exercise machines connected to a computer network that enables an individual to input a code on an exercise machine identifying the particular individual, such that the performance data from a given exercise session can be recorded from the exercise machine and stored under a file name for the individual located on the network. Systems of this type are typically only available in a club environment.

One significant disadvantage with systems of this type is that the individual must remember or carry an identifying code in order to ensure that the performance data is stored in the individual's file. In addition, systems of this type require that the exercise machines, which initially generate the performance data for the individual, be operably connected to a computer network, often at a significant expense.

One alternative to these prior art systems takes the form of exercise machines that enable an individual to store the performance data generated from a number of exercise sessions directly on the exercise machine. These systems negate the need for networking the exercise machine to a computing unit, as the performance data is stored directly on the exercise machine. However, because the performance data is contained on the device, in the event an individual chooses to exercise on a different device or at a different location, the performance data from the different device cannot be readily transferred from or to the device that was initially used by the individual. Further, the data recorded on the exercise machine cannot be readily analyzed on the exercise machine to provide the more detailed results that can be provided by the networked system.

In addition, it is often necessary for a user to input certain information in an exercise machine before using the machine. Such information may be the user's club identification number, weight, target heart rate, desired program setting, etc.

To address these drawbacks, systems have been developed which enable a user of exercise machine to record parameters associated with an exercise session on a memory device. The memory device may also include user-specific information that can be used to configure the exercise machine for the user. However, such systems typically require the use an intermediate device when interfacing with a data storage device, such as a personal computer. For example, it may be necessary to interconnect a memory card reader with a personal computer in order to acquire information relative to an exercise session and to communicate such information to the personal computer.

Therefore, it is desirable to develop such a device that does not involve the complications and expense associated with an intermediate device, in order to interface with an exercise machine and with a data storage device such as a personal computer. It is also desirable to develop such a device for inputting user information into an exercise machine, and for storing the performance data from any number of exercise sessions. In addition, it is desirable to develop a device that allows an individual to quickly and easily store both personal performance data and other identifying data in a manner that allows the data to be easily transferred and utilized between a wide range of exercise machines and environments. It is also desirable that the device be capable of being utilized in conjunction with a computer to enable more detailed analyses of the data to be performed.

To this end, according to a primary aspect of the present invention, an exercise data storage device is provided that enables an individual to record and download performance data for a number of exercise sessions that can be freely utilized with varying exercise machines. The device provides the capability to connect the data storage device directly to a specific exercise machine and thereby provide an interface between the data storage device and the exercise machine for the recording and/or downloading of performance data for the individual, in conjunction with other information, such as the individual's ID or settings for that exercise machine. In addition, the data storage device allows for the wireless downloading and recording of performance data obtained by the data storage device from either a piece of exercise equipment, and/or a number of sensors disposed on the exercise equipment and/or on the individual that transmit performance data signals to the data storage device. In addition, the data storage device can be connected to a computer, either directly via the Universal Serial Bus (USB) or in a wireless manner, such that performance data can be transmitted by the data storage device to and from a computer in order to provide an individual with the capability to analyze the data transmitted to the computer by the data storage device. Two versions of the USB standard are available, USB 1.1 Specification (“USB 1.1”) and USB 2.0 Specification (“USB 2.0”) in addition to the On-The-Go supplement to USB 2.0, the disclosures of which are hereby incorporated in their entirety.

According to another aspect of the present invention, a wireless data storage device is capable of use in either a mechanical interface or wireless interface mode, with the mechanical interface mode simultaneously supplying power to the data storage device and/or charging the battery for the data storage device in order to enable the data storage device to be utilized for a prolonged period of time in the wireless mode.

Numerous other features, objects and advantages of the present invention will be made apparent from the following detailed description taken together with the drawing figures.

### BRIEF DESCRIPTION OF THE DRAWINGS

The drawings illustrate the best mode currently contemplated as practicing the present invention.

In the drawings:

FIG. 1 is a perspective view of a multi-functional USB exercise data storage device constructed according to the present invention;

FIG. 2 is a schematic illustration of the device of FIG. 1 utilized in a mechanical connection configuration with a piece of fitness equipment;

FIG. 3 is a schematic view of the device of FIG. 1 utilized in conjunction with a personal computer for uploading and analyzing data stored on the device;

FIG. 4 is a schematic view of the device of FIG. 1 utilized in a wireless configuration to record performance data from a plurality of sensors;

FIG. 5 is a block diagram of the multi-functional USB device of FIG. 1;

FIG. 6 is a side view of the device of FIG. 1 utilized in a mechanical connection configuration with a piece of a fitness equipment;

FIG. 7 is a circuit diagram of the device of FIG. 1; and

FIG. 8 is a circuit diagram of the device of FIG. 1 without the wireless option.

### DETAILED DESCRIPTION OF THE INVENTION

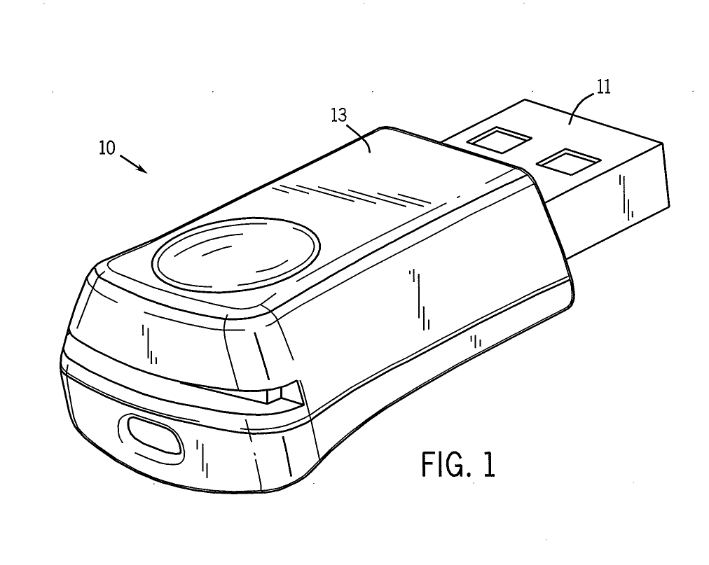

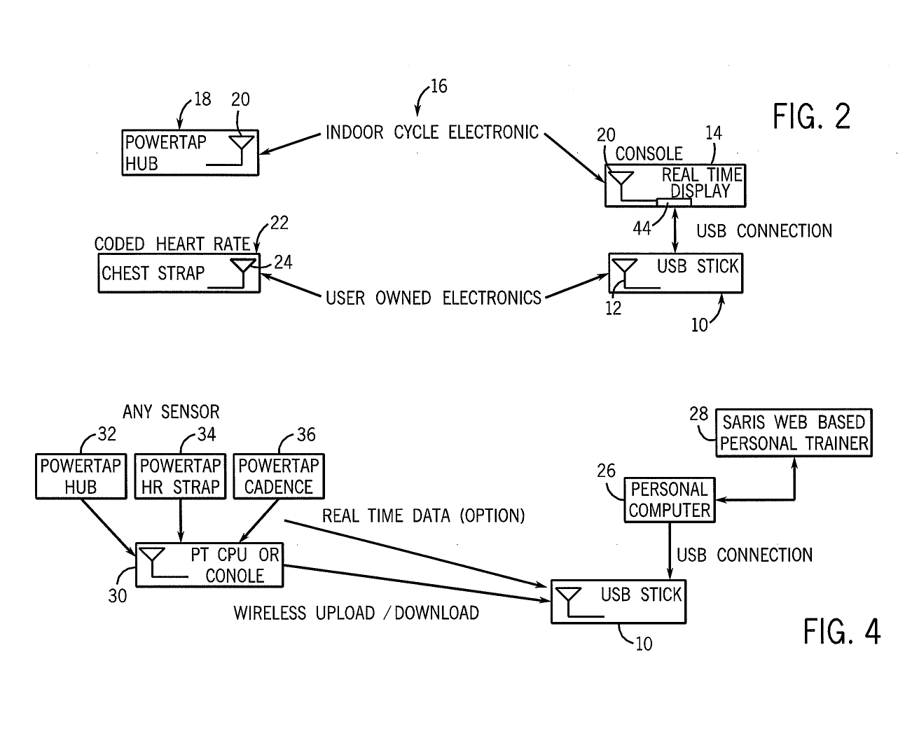

With reference now to the drawing figures in which like reference numerals designate like parts throughout the disclosure, a performance recording and transmitting device is indicated generally at 10 in FIG. 1. The device 10 is preferably formed as a USB drive, also known as “flash” or “jump” drives. The device 10 contains a form of non-volatile computer memory that can be electrically erased and reprogrammed such as flash memory, EEPROM or RAM and is directly connectable to a number of other devices utilizing a standard male USB interface connector 11. The device 10 may also include an internal antenna 12 (FIG. 2) that is capable of either transmitting or receiving wireless signals from a variety of other devices in order to transmit or record data from the device 10. The device 10 may be overmolded with an elastomeric or polymeric material 13 to give it an aesthetic yet rugged design. The overmolded material 13 may be formed to provide depressions and a hook feature to aid in removal from a console 14 or computer. The internal components of the device 10 are sealed to withstand sweat from use and handling and from a humid environment. A cap (not shown) covers the connector 11 when the device 10 is not in use for further protection. A short lanyard may be provided to assist in carrying or storing the device 10. The lanyard may be connected to the cap to ensure that the cap is not lost during workouts or it may be connected to the device 10 itself.

In FIG. 2, the device 10 is illustrated as being connected to a console 14 of an exercise machine 16 in order to directly receive performance data from the exercise machine 16. The exercise machine 16 also includes a separate sensing device 18 that measures one or more parameters of the exercise being performed on the exercise machine 16 by an individual, and generates exercise performance data representative of the measured parameters. When utilizing the exercise machine 16, the performance data generated by the exercise machine sensing device 18 is transmitted through the console 14 for real time display to the individual. By using the interface connector 11, the device 10 can be connected directly to the console 14 to record the data displayed by the console 14.

As previously stated, the preferred communication protocol of the device 10 is a USB drive device. However, the USB 1.1 standard does not support peer to peer communication but instead is host controlled. This means that at least one device on a USB bus must be a host device, such as a personal computer (PC), in order to control and direct the communication between devices. If the host device is removed from the bus, the other peripheral, i.e., slave, devices cannot communicate with each other. For example, a peripheral device such as a digital camera operating under the USB 1.1 standard may communicate and transfer files directly to a PC (a host) but cannot communicate directly with another peripheral device such as a printer or PDA. However, adding a USB host device inside of a low-cost console 14 or the device 10 is both technically challenging and expensive.

One attempt to solve this problem was the development of the USB “On-The-Go” (OTG) supplement to USB 2.0. OTG permits the use of a dual role device, which can function as both a device controller and/or a host controller as needed, thereby providing the ability for peripheral devices to communicate with other connected devices without requiring an active host controller. A dual role device detects the absence of a host controller and enables itself as a host, or master, device communicating with other peripheral devices. However, it takes a substantial amount of development and financial resources to develop or convert a device to the USB 2.0 standard. Further, this standard makes sense for high speed disk drives and digital video cameras to switch to USB 2.0, but is not feasible for devices such as the console 14. Finally, switching to the USB 2.0 standard does nothing for the installed base of consoles 14 operating under USB 1.1.

Another attempt to permit USB 1.1 peripheral devices to communicate directly with other USB 1.1 peripheral devices is the Delkin USB Bridge. The USB Bridge is a stand-alone device that transfers data from one peripheral device to another, regardless of whether there is a master/host device available. However, this solution is undesirable as it adds expense, must be carried with the device 10 and could easily be lost or stolen.

Therefore, in accordance with the present invention, a cost-effective hardware solution was developed to enable the USB peripheral device 10 to communicate with the USB peripheral console 14 in a non-USB format.

Referring now to FIGS. 2, 3, 5, 7 and 8, the device 10 is first plugged into a standard USB port via the interface connector 11. If the device 10 is plugged into a USB port 40 of a personal computer 26 in which the computer 26 is a host, the device 10 operates as a standard USB peripheral device. In this scenario, a USB to asynchronous serial data interface, i.e., USB bridge or transceiver, 60, interfaces between the computer 26 and a microcontroller 62 located inside of the device 10. The USB bridge 60 converts USB-standard 5V logic level signals to a standard 3V (TTL—transistor to transistor) logic level signal, matching the logic level at which other components of the circuit 64 of the device 10 operate.

If the device 10 is plugged into a USB port 44 of a console 14 in which the console 14 is a peripheral device, a low voltage detector 66 in the device 10 activates a CMOS SPDT switch 68, to bypass the USB bridge 60, essentially switching the bridge 60 out of the circuit 64. Instead of communicating through USB bridge 60, serial communications, at the aforementioned 3V logic level, are routed directly to the microcontroller 62 and serial flash memory 70.

A power supply 72 provides power to the device 10 and associated components. An optional 2.4 GHz transceiver 74 may also be provided for alternative embodiments of the device 10 utilizing wireless communications.

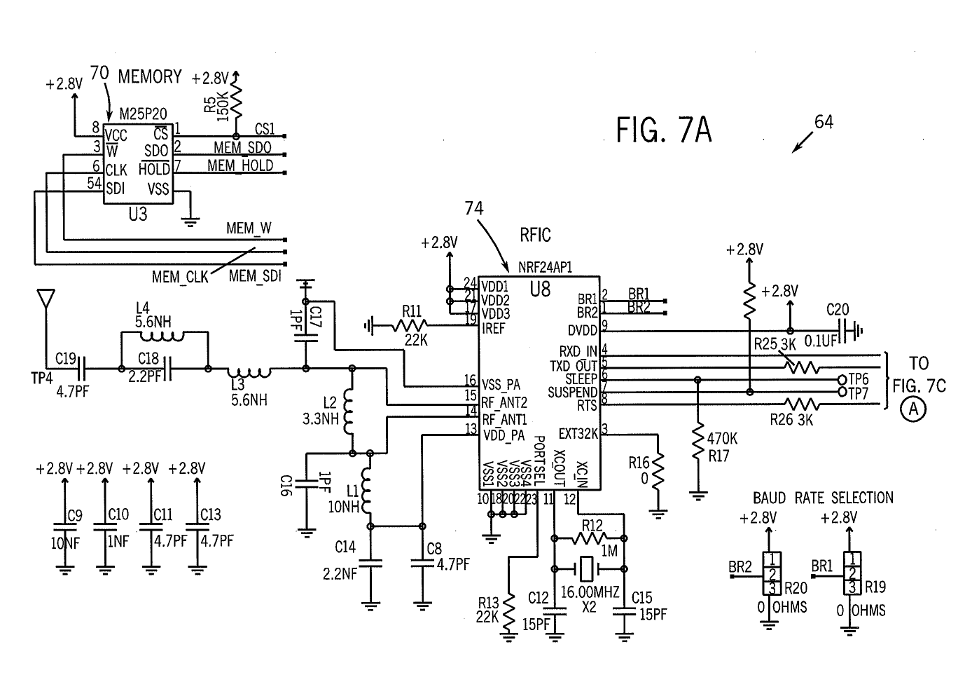

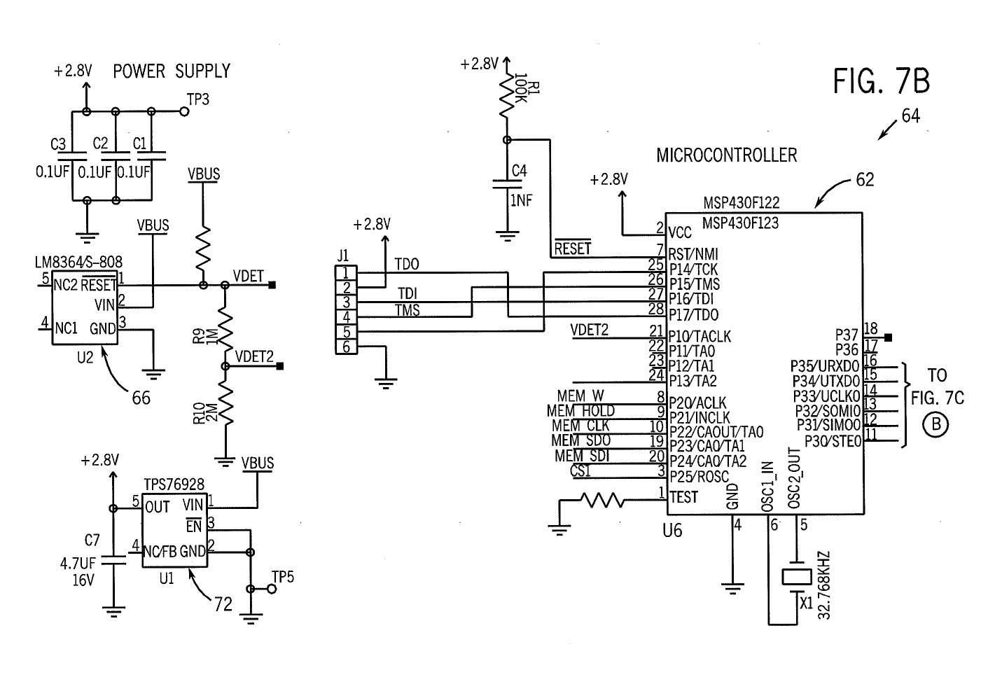

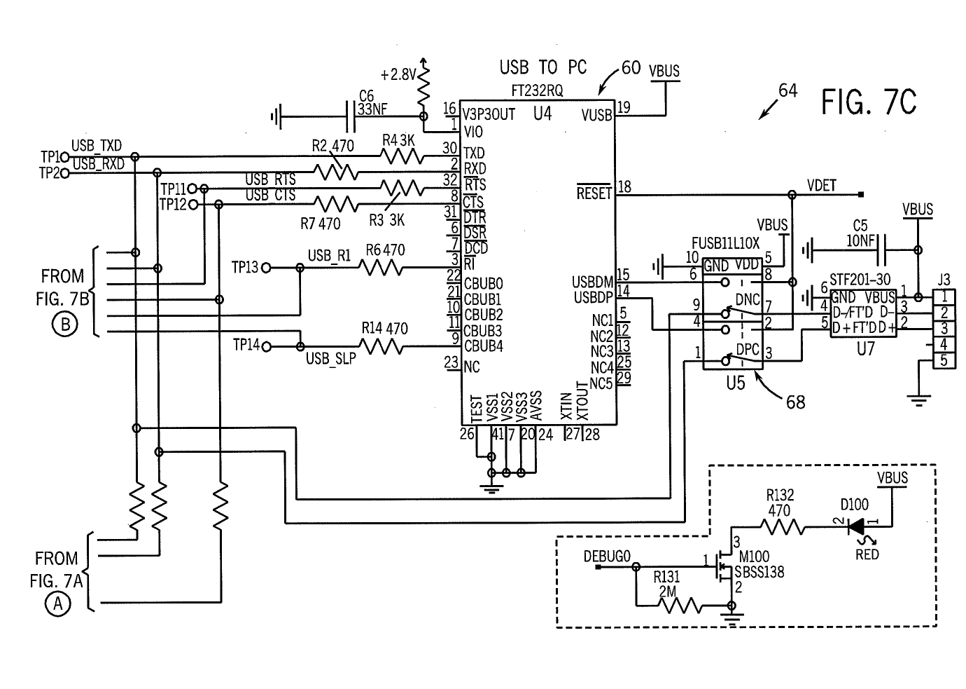

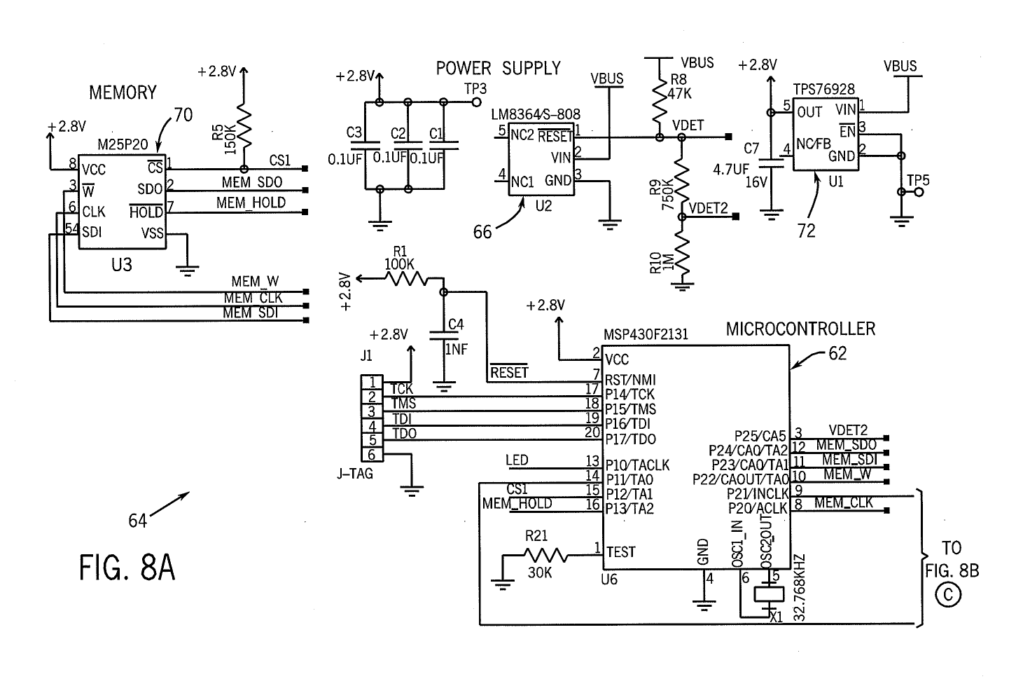

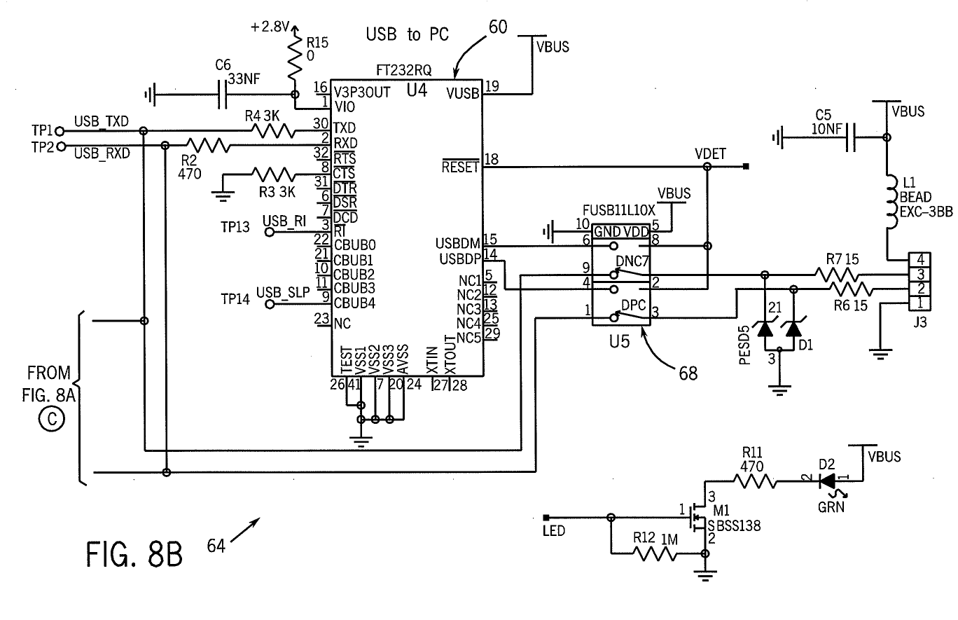

In one embodiment, the low voltage detector 66 is part number LM8364BALMF45 from National Semiconductor, the CMOS SPDT switch 68 is part number FSUSB11L10X from Fairchild Semiconductor, the USB bridge 60 is part number FT232RQ from Future Technology Devices International, Ltd., the microcontroller 62 is part number MSP430F2132 from Texas Instruments (TI), and the serial flash memory 70 is part number M25P20-VMN6TP from ST Microelectronics. Additional components include a battery, e.g., power supply 72, part number TP76928DBVR from TI and the optional 2.4 GHz transceiver 74, part number nRF24AP1 from Nordic Semiconductor. The components of the device 10 are shown in a block diagram in FIG. 5 and the circuit diagrams of FIGS. 7 and 8. The circuit diagram of FIG. 7 shows the device 10 with wireless functionality while the circuit diagram of FIG. 8 shows the device 10 without wireless capabilities.

In one preferred embodiment, the recording of the data by the device 10 is accomplished in a real time manner, such that, as the data is generated by one or more of the console 14, or sensing device 18, the data is recorded on the device 10 in 1.26 second intervals. Thus, when the individual finishes an exercise session, the device 10 can be immediately disconnected from the console 14, or switched off if the device 10 is being used in a wireless manner, without any time required for the downloading of information stored in the console 14 to the device 10.

The device 10 can also be used to store information to assist the individual in using each exercise machine 16, such as an ID for the user, or set-up information for the various parameters of the exercise machines 16 or workout goals. Thus, when the device 10 is connected to the console 14, this information is transmitted from the device 10 to the console 14, in order to authorize the individual to use a particular device 16, or set the resistance, speed, and other functions of the exercise machine 16 to the preferences or parameters specified for (or desired by) the individual.

Additionally, both the sensing device 18 and console 14 can include antennas 20 that enable the performance data from the exercise machine 16 to be transmitted in a wireless fashion directly to the antenna 12 on the device 10. Further, FIG. 2 illustrates a chest strap 22 that can be affixed to the individual performing the exercise, and which generates signals representative of the heart rate of the individual performing the exercise. These signals can also be transmitted from the chest strap 22 via an antenna 24 to the antenna 12 for recording by the device 10.

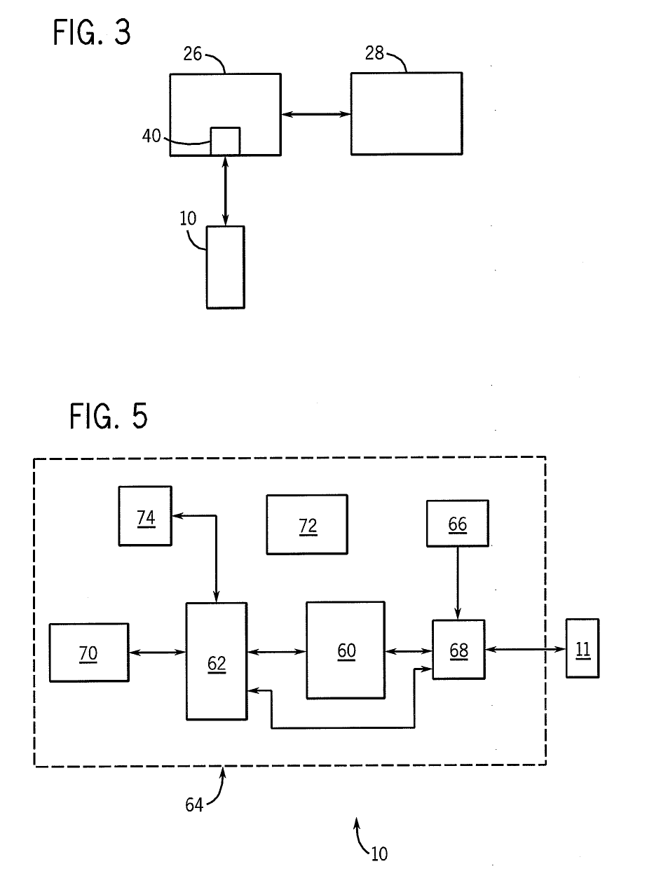

Referring now to FIG. 3, once an exercise session has been completed, the device 10 is disconnected from the console 14 and can be connected to a personal computer 26. The data can preferably be downloaded to the computer 26 via Power Tap PC download software, developed and sold by Saris Cycling Group, Inc. of Madison, Wis., the owner of this patent application. The device 10 communicates with the computer 26 using a USB protocol. When the device 10 is connected to the computer 26, the low voltage detector 66 no longer detects the 3V TTL logic of the console 14 but instead detects the 5V USB logic. Thereafter, switch 68 switches the USB bridge 60 back into the circuit 64 and serial communications are routed through the bridge 60.

The personal computer 26 can be utilized to analyze and manipulate the data recorded and stored on the device 10 during the exercise session, because the performance data is downloaded from the device 10 to the personal computer 26. Further, the computer 26 can be utilized in conjunction with a web-based personal trainer 28 that is accessible from the computer 26, to analyze the performance data and determine both the performance characteristics for the individual and any alterations to the set-up parameters for the exercise machine 16 or training targets in a subsequent exercise session.

With regard to the connection of the device 10 to either the console 14 or the personal computer 26, the physical connection of the device 10 to the console 14 and computer 26 via the interface 11 also provides the device 10 with a power supply in order to operate the device 10, and to charge a battery (not shown) located within the device 10. By charging the battery, the device 10 can be utilized in a wireless manner when an individual is performing an exercise session utilizing an exercise machine 16 that does not include a console 14.

Such a situation is illustrated in FIG. 4, in which the device 10 is continually receiving and transmitting data from a personal training computer 30 that is operably connected to a number of sensors 32-36. The sensors 32-36 obtain the performance data created by the individual when performing an exercise session on any exercise machine. The data obtained by the sensors 32-36 can be transmitted directly from the sensors 32-36 to the device 10 in a real time manner, but can also be routed through the computer 30 prior to being transmitted to the device 10 in order to provide a real-time representation of the performance data obtained from the sensors 32-36 or the computer 30. This configuration is useful when an individual is performing a monitored exercise session and the computer 30 providing the real-time display is disposed at a location separate from the individual for monitoring by another person. However, once the exercise session is completed, the performance data transmitted to and stored on the device 10 can then be downloaded from the device 10 onto a personal computer 26, as shown and discussed with regard to FIG. 3, for manipulation of the data utilizing in a preferred embodiment the web-based personal trainer 28. However, once the exercise session is completed, the performance data transmitted to and stored on the device 10 can then be downloaded from the device 10 onto a personal computer 26, as shown and discussed with regard to FIG. 3, for manipulation of the data utilizing in a preferred embodiment the web-based personal trainer 28.

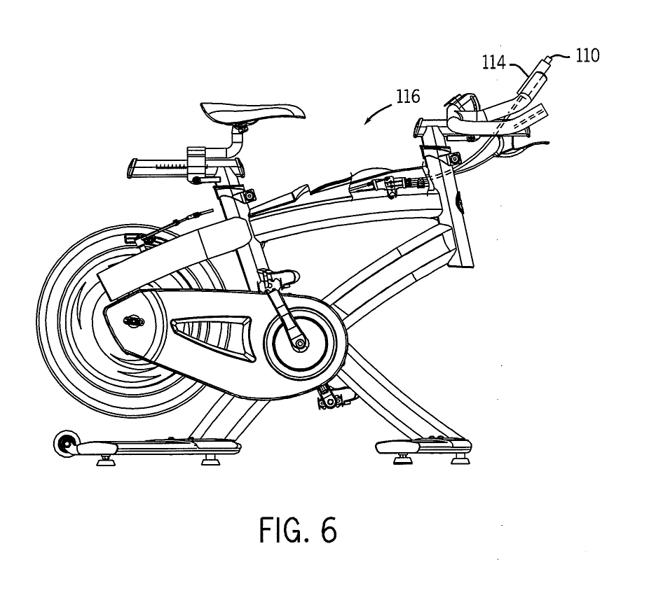

FIG. 6 illustrates a device 110 connected to the console 114 of a cycling exerciser, shown generally at 116, in order to directly receive performance data from the cycling exerciser 116. Before use, the device 110 may first be connected to a personal computer. Therefore, on power up, any available features, e.g., time and date, bulk erase, etc., will be done using the current host command structure of either a computer or console 114 of the exerciser 116.

Once the device 110 is connected to the computer and powered up, a user profile, having been created and residing on the computer, is uploaded to the device 110. The device 110 will store one user profile in the flash memory of the device 110. The device 110 is then removed from the computer until needed.

When the user wants to use the device 110 in conjunction with the exerciser 116, the device 110 is inserted into the console 114 of the exerciser 116. The device 110 is powered by the console 114, a peripheral USB device, in the manner previously discussed. The device 110 then records real-time exercise data in the form of binary data files saved in the memory of the device 110. The communications are in the form of a 3V wired asynchronous UART connection in which incoming data occurs every 1.26 seconds.

If wireless sensors are used, the extra information, e.g. sensor ID number, heart rate, power zones, speed, cadence, training target, etc., may also stored on the device 110. Furthermore, the device could wirelessly upload and download from a computer to display real time data while a user is using the exerciser 116. One the user is done using the exerciser 116, the device 110 is removed from the console. The data resides on the device 110 and therefore does not need to be downloaded from the console 114.

If the wireless feature is not available, the user can instead connect the device 110 to a personal computer. The data residing on the device 110 is downloaded to the computer for analysis and review by any suitable software application. A historical record of the user's exercise data may be kept on the computer.

It should be understood that the data storage and communication device of the present invention may be used in conjunction with any type of exercise equipment, and that exerciser 116 is simply one example of an exercise device in connection with which the data storage and communication device may be employed. Furthermore, it is understood that the data storage and communication device of the present invention may be used in other non-exercise applications in order to record information from a slave-type USB device and to interface with a data storage device such as a personal computer without the need for an intermediate reader or other interface between the personal computer and the data storage and communication device.

Various other embodiments of the invention are contemplated as being within the scope of the following claims particularly pointing out and distinctly claiming the subject matter regarded as the invention.

What is claimed is:

1. An exercise system for use by a user, comprising:
an exercise machine; and
a data storage device for use with the exercise machine, wherein the data storage device stores user-specific data pertaining to use of the exercise machine by the user, and wherein the data storage device includes an interface for receiving information from the exercise machine and transmitting information to the exercise machine.

2. The exercise system of claim 1, wherein the data storage device includes a memory for storing user information such as a user identification or user-specific operating parameters for the exercise machine.

3. The exercise system of claim 2, wherein the interface comprises a mechanical connection of the data storage device to the exercise machine.

4. The exercise system of claim 3, wherein the interface includes an antenna and receiver arrangement.

5. An exercise method, comprising the acts of storing user-specific data on a portable data storage device, and interfacing the portable data storage device with an exercise machine for communicating user-specific information between the exercise machine and the data storage device.

6. The method of claim 5, wherein the act of communicating user-specific information between the exercise machine and the data storage device includes transmitting user information to the exercise machine from the data storage device, and transmitting information from the exercise machine to the data storage device relating to operation of the exercise machine by the user.

7. The method of claim 6 wherein the step of communicating between the exercise machine and the data storage device is accomplished with a USB standard without the need for a USB host device.

8. A USB device comprising:
a communication port;
a low voltage detector;
a processor;
a memory;
a USB-compatible switch; and
a USB bridge, wherein if the voltage detector detects a voltage of less than a predetermined value, the bridge is bypassed so as to establish direct communication between the communication port and the processor.

9. The USB device of claim 8, wherein the processor comprises a microcontroller.

10. The USB device of claim 9, wherein the memory comprises at least one of a Flash, EEPROM and RAM memory.

11. The USB device of claim 8, further comprising:
an overmolded covering;
a cap; and
an interface connector connected to the communication port;
wherein the cap covers the interface connector when not in use.

12. An integrated circuit for a first peripheral USB device comprising:
a data interface;
a USB transceiver;
a processor; and
a switch; wherein the switch is activated in response to a low voltage signal to establish a point-to-point connection between the processor and a second peripheral USB device.

13. The integrated circuit of claim 12 further comprising a low voltage detector, wherein the detector is operative for activating the switch.

14. The integrated circuit of claim 12 further comprising a memory.

15. The integrated circuit of claim 14 wherein the memory is at least one of a Flash, EEPROM and RAM memory.

16. A method for establishing communications between two peripheral USB devices, the method comprising:
providing a first peripheral USB device comprising a microcontroller, a low voltage detector, a switch and a USB bridge circuit; wherein the bridge circuit converts 5V USB-standard logic to 3V TTL logic;
configuring the first peripheral USB device to bypass the USB bridge circuit when a low voltage is detected;
connecting the first peripheral USB device to the second peripheral USB device;
detecting a low voltage;
bypassing the USB bridge to permit logic communications between the microcontroller and second peripheral device directly.
